(19) United States
(12) Patent Application Publication
(10) Pub. No.: US 2026/0179520 A1
(43) Pub. Date: Jun. 25, 2026

(54) DISPLAY DEVICE INCLUDING DISPLAY PANEL, METHOD TO OPERATE THE SAME, AND DISPLAY SYSTEM INCLUDING THE SAME

(71) Applicant: SAMSUNG DISPLAY CO., LTD., YONGIN-SI (KR)

(72) Inventors: Jong Man KIM, Yongin-si (KR); Byeong Doo KANG, Yongin-si (KR); Kyoung Ho LIM, Yongin-si (KR); Seung Ho PARK, Yongin-si (KR); Joon Hyeok JEON, Yongin-si (KR)

(21) Appl. No.: 19/342,812

(22) Filed: Sep. 29, 2025

(30) Foreign Application Priority Data
Dec. 20, 2024 (KR) 10-2024-0192785

(51) Int. Cl. G09G 3/20

(52) U.S. Cl. CPC G09G 3/2037; G09G 2310/027; G09G 2320/0233; G09G 2320/0257; G09G 2320/045; G09G 2360/127; G09G 2360/16

(57) ABSTRACT

A display device includes a display panel including pixels, a controller configured to control the display panel, and a working memory connected to the controller. The controller is configured to: update accumulated stress data corresponding to the pixels based on first image frames, determine a representative value of the source data units obtained from the accumulated stress data, change a portion of data bits of each of the source data units according to the representative value, and encode the changed source data units to generate compressed data and store the compressed data in the working memory.

### CROSS-REFERENCE TO RELATED APPLICATION

This U.S. patent application claims priority under 35 U.S.C. § 119(a) to Korean Patent Application No. 10-2024-0192785, filed on Dec. 20, 2024, which is hereby incorporated by reference in its entirety herein.

### TECHNICAL FIELD

Embodiments of the invention are directed to an electronic device, and more particularly, to a display device including a display panel, an operating method thereof, and a display system including the same.

### DISCUSSION OF RELATED ART

The display device may operate with relatively low power consumption and fast response speed by using a light emitting diode (LED) or an organic light emitting diode (OLED) as a light source.

The luminance of the display device is determined by the driving current flowing through the light-emitting diode of each pixel. For example, in the case of a high luminance image, a driving current greater than that of a low luminance image may be required.

Each pixel may experience stress based on the driving current applied during operation, and this stress may lead to degradation over time. As degradation progresses, the pixel may emit light at a reduced luminance even when driven by the same gradation data, resulting in deterioration of display quality.

An image sticking compensation technology may be used to track the accumulated stress or degradation level of each pixel and adjust a data voltage applied to the pixel accordingly, thereby helping to remove image sticking artifacts. However, these techniques require storing a large volume of stress-related data, which can place significant demands on memory capacity and processing bandwidth, potentially leading to inaccurate compensation and visible issues such as reduced luminance or image sticking.

### SUMMARY

Embodiments provide a display device having enhanced reliability, a method for operating the same, and a display system including the same.

A display device according to an embodiment includes: a display panel including pixels; a controller configured to control the display panel; and a working memory connected to the controller. The controller is configured to: update accumulated stress data corresponding to the pixels based on first image frames; determine a representative value of source data units obtained from the accumulated stress data; change a portion of data bits of each of the source data units according to the representative value, to generate changed source data unit; and encode the changed source data units to generate compressed data, and store the compressed data in the working memory.

The controller may be configured to change one or more least significant data bits of the data bits of each of the source data units to a first logic level to generate the changed source data units.

The number of the least significant data bits changed to the first logic level may be adjusted according to the representative value.

A number of the least significant data bits changed to the first logic level may increase as the representative value increases.

The controller may be configured to maintain the source data units when the representative value is within a first range, and the controller may be configured to change at least one least significant data bit of the data bits of each of the source data units to a first logic level when the representative value is within a second range greater than the first range.

The controller may be configured to: change n least significant data bits of the data bits of each of the source data units to a first logic level when the representative value is within a first range, where n is an integer greater than 1; and change m least significant data bits of the data bits of each of the source data units to the first logic level when the representative value is within a second range greater than the first range, where m is an integer greater than n.

The controller may be configured to convert a second image frame based on the compressed data when the second image frame is received, and an image may be displayed on the display panel according to the converted second image frame.

When a second image frame is received, the controller may be configured to perform decoding the compressed data to generate compensation data, and convert the second image frame according to the compensation data, and an image may be displayed on the display panel according to the converted second image frame.

The representative value may be determined according to the values of the source data units.

A maximum value of the values of the source data units may be determined as the representative value.

The pixels may be grouped into a plurality of display areas; an average value of values of the source data units corresponding to each of the display areas may be determined as an area value corresponding to a display area; and the representative value may be determined according to the determined area values of the display areas.

A maximum value of the determined area values of the display area may be determined as the representative value.

The pixels may be grouped into a plurality of pixel groups, the accumulated stress data may include accumulated stress data units respectively corresponding to the plurality of pixel groups, and the controller may be configured to extract the source data units from the accumulated stress data units.

A method to operate a display device including pixels according to embodiments includes: obtaining source data units from the accumulated stress data corresponding to the pixels; determining a representative value corresponding to the source data units; changing a portion of data bits of each of the source data units according to the representative value; and encoding on the changed source data units to generate compressed data.

The method may further include displaying an image in the pixels based on an image frame and the compressed data. The displaying the image in the pixels may include: decoding on the compressed data to generate compensation data; converting the image frame according to the compensation data; and displaying the image in the pixels according to the converted image frame.

The changing may include changing one or more least significant data bits of the data bits of each of the source data units to a first logic level.

A number of the least significant data bits changed to the first logic level may be adjusted according to the representative value.

A maximum value of the values of the source data units may be determined as the representative value.

The pixels may be grouped into a plurality of display areas; an average value of values of the source data units corresponding to each of the display areas may be determined as an area value corresponding to a display area, and the representative value may be determined according to the determined area values of the display areas.

An electronic device according to embodiments includes: a processor; and a display device configured to display an image in pixels according to image data from the processor. The display device includes: a display panel including the pixels; a controller configured to control the display panel; and a working memory connected to the controller. The controller is configured to: update accumulated stress data corresponding to the pixels based on first image frames; determine a representative value of the source data units obtained from the accumulated stress data; change a portion of data bits of each of the source data units according to the representative value, to generated changed source data units; and encode the changed source data units to generate compressed data, and store the compressed data in the working memory.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a block diagram illustrating a display device according to an embodiment.

FIG. 2 is a graph illustrating change in luminance of the display panel of FIG. 1 according to accumulated stress applied to the display panel.

FIG. 3 is a block diagram illustrating an embodiment of the control board of FIG. 1.

FIG. 4 is a diagram conceptually illustrating pixel groups of the display panel of FIG. 1 and data pixel groups of a reference image frame.

FIG. 5 is a diagram conceptually illustrating processes of updating accumulated stress data based on a reference image frame.

FIG. 6 is a block diagram illustrating an embodiment of the compensation information generation unit of FIG. 3.

FIG. 7 is a diagram conceptually illustrating processes of generating compressed compensation data from accumulated stress data in the compensation information generation unit of FIG. 6.

FIG. 8 is a diagram conceptually illustrating processes of restoring compensation data from compressed compensation data in the compensation information generation unit of FIG. 6.

FIG. 9 is a block diagram illustrating an embodiment of the compensation information generator of FIG. 6.

FIG. 10 is a conceptual diagram illustrating an accumulated stress data unit and a source data unit extracted therefrom.

FIGS. 11 and 12 are diagrams for illustrating embodiments of a method of determining a representative value of source data units.

FIG. 13 is a diagram conceptually illustrating a plurality of ranges to which a representative value may belong.

FIGS. 14A to 14D are diagrams conceptually illustrating a compensation data unit generated according to a representative value.

FIG. 15 is a block diagram illustrating an embodiment of the deterioration compensation unit of FIG. 3.

FIG. 16 is a flowchart illustrating a method of operating a display device according to an embodiment.

FIG. 17 is a flowchart illustrating an embodiment of step S130 of FIG. 16.

FIG. 18 is a flowchart illustrating an embodiment of step S131 of FIG. 17.

FIG. 19 is a flowchart illustrating an embodiment of step S132 of FIG. 17.

FIG. 20 is a block diagram illustrating a display system according to an embodiment.

FIG. 21 is a block diagram illustrating an electronic device according to an embodiment.

### DETAILED DESCRIPTION

Hereinafter, example embodiments according to the present disclosure will be described in detail with reference to the accompanying drawings. In the following description, it is to be noted that only parts needed to understand the operation according to the present disclosure will be described, and description of other parts will be omitted to avoid obscuring the gist of the present disclosure. In addition, the present disclosure is not limited to the embodiments described herein, and may be embodied in different forms. The embodiments described herein are provided for the purpose of describing the technical idea of the present disclosure in sufficient detail for those of ordinary skill in the art to which the present disclosure pertains to carry out the technical idea of the present disclosure.

Throughout the specification, when it is described that an element is “connected” to another element, this includes not only being “directly connected”, but also being “indirectly connected” to each other with still another element interposed therebetween. The terms used herein are for the purpose of describing specific embodiments and are not intended to limit the scope of the present disclosure. Throughout the specification, unless specifically described to the contrary, the word “include” and variations such as “includes” or “including” will be understood to imply the inclusion of stated elements but not the exclusion of any other elements. The terms “at least one of X, Y, and Z” and “at least one selected from the group consisting of X, Y, and Z” may be construed as X only, Y only, Z only, or any combination of two or more of X, Y, and Z (e.g., XYZ, XYY, YZ, and ZZ). As used herein, the term “and/or” includes any one or all combinations of one or more of corresponding configurations.

Although the terms “first, second, and so on” may be used herein to describe various constituent elements, these constituent elements should not be limited by these terms. These terms are used to distinguish one constituent element from another. Thus, a first constituent element discussed below can be called a second constituent element without departing from the teachings of the present disclosure.

At least one embodiment of the invention relates to a display device that enhances compensation for pixel degradation. A compensation information generator obtains source data units derived from accumulated stress data for pixel groups. Based on a representative value indicating the complexity of these units, it changes one or more least significant bits of each source data unit to a fixed logic level, generating compensation data units with lower complexity. These are compressed, and later decoded into restoration data, which is used to adjust image frames and compensate for pixel wear. Because only the least significant bits are changed, the restoration data closely reflects the original stress information, ensuring reliable image correction on the display. The embodiment addresses the problem of managing large volumes of degradation-related data that need to be stored and processed in real time. As pixel stress accumulates across the display, the resulting data can become both dense and highly variable, making it difficult to compress and restore accurately within limited memory and bandwidth constraints. By reducing the variability of the least significant bits according to the representative value, the embodiment ensures that the compensation data is more compression-friendly while still accurately capturing degradation trends. This allows the display to maintain consistent image quality over time without excessive memory overhead.

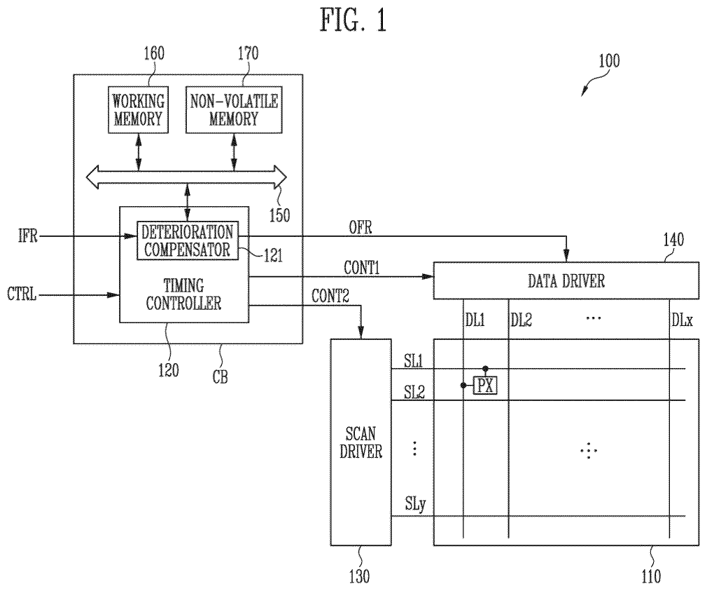

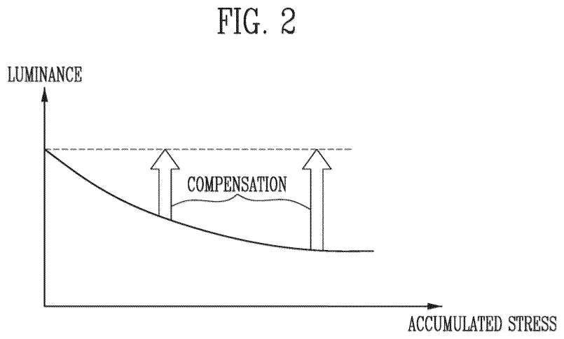

FIG. 1 is a block diagram illustrating a display device according to an embodiment. FIG. 2 is a graph illustrating change in luminance of the display panel of FIG. 1 according to accumulated stress applied to the display panel.

Referring to FIG. 1, a display device 100 includes a display panel 110, a timing controller 120 (e.g., a controller circuit), a scan driver 130 (e.g., a first driver circuit), and a data driver 140 (e.g., a second driver circuit).

The display panel 110 includes pixels PX. The pixels PX are connected to scan driver 130 via first to y-th scan lines SL1 to SLy and to data driver 140 via first to x-th data lines DL1 to DLx.

Each of the pixels PX may include a light-emitting element and transistors for driving the light-emitting element. In embodiments, the light emitting device may include an organic light emitting diode and/or an inorganic light emitting diode configured to emit light of a particular color. For example, each pixel may be any one of a red sub-pixel, a green sub-pixel, and a blue sub-pixel.

The timing controller 120 controls various operations of the display device 100. The timing controller 120 receives an input image frame IFR and control signals CTRL for controlling its display. For example, the control signals CTRL may include a vertical synchronization signal, a horizontal synchronization signal, a main clock signal or a data enable signal.

According to an embodiment of the present disclosure, the timing controller 120 includes a deterioration compensator 121 (e.g., a logic circuit). The degradation compensator 121 may be configured to estimate stress applied to the pixels PX according to operations of the display panel 110, and perform compensation on the input image frame IFR (e.g., input image data for a single frame) according to the estimated stress to generate a modified image frame (e.g., modified image data). For example, the input image data for one frame may be compensated based on a value of the estimated stress to generate modified image data for the one frame.

In embodiments, an input image frame IFR may be provided with additional processes and/or compensation performed on an image stream received from outside. These additional processes and/or compensation may be performed by the timing controller 120. In other embodiments, an externally received image stream may be provided to the degradation compensator 121 as an input image frame IFR.

The timing controller 120 may perform additional compensation operations on the modified image frame to generate an output image frame OFR (e.g., output image data for the frame). Also, based on the control signals CTRL, the timing controller 120 may perform various processes on the output image frame OFR, such as changing its data format and/or arrangement of the output image frame to be suitable for the display panel 110. The timing controller 120 displays the image on the display panel 110 by providing the output image frame OFR to the data driver 140.

The timing controller 120 may transmit a first control signal CONT1 to the data driver 140 and a second control signal CONT2 to the scan driver 130 based on the control signals CTRL. In embodiments, the first control signal CONT1 may include a clock signal and a line latch signal, and the second control signal CONT2 may include a vertical synchronization start signal or an output enable signal.

The scan driver 130 drives each of the first to y-th scan lines SL1 to SLy in response to the second control signal CONT2 from the timing controller 120. In embodiments, the scan driver 130 may be implemented as a circuit using an oxide semiconductor, a crystalline semiconductor or a polycrystalline semiconductor. The scan driver 130 may be formed at the same time as the pixels PX, and in this case may be mounted on the display panel 110.

The data driver 140 may drive the first to x-th data lines DL1 to DLx in response to the first control signal CONT1. The data driver 140 may output grayscale voltages corresponding to the output image data OFR to the first to x-th data lines DL1 to DLx in response to the first control signal CONT1.

When each of the scan lines SL1 to SLy is driven to a gate-on voltage by the scan driver 130, gradation voltages corresponding to the gradation values of the output image data OFR may be applied to the data lines DL1 to DLx. Accordingly, the grayscale voltages corresponding to the output image data OFR may be provided to the pixels PX of the corresponding scan line. Accordingly, the pixels PX may emit light of a luminance corresponding to the grayscale voltages.

In this way, the timing controller 120 may drive the display panel 110 through the scan driver 130 and the data driver 140 to display an image.

Referring to FIG. 2, the horizontal axis denotes accumulated stress applied to a pixel of the display panel 110 of FIG. 1, and the vertical axis denotes luminance generated in response to image data (e.g., OFR of FIG. 1) of the same grayscale value of the corresponding pixel. In FIG. 2, as stress accumulates in the pixel, the reduction in luminance the emitted light may become more pronounced. For example, as the accumulated stress increases, the pixel may gradually deteriorate and emit light at a reduced luminance in response to the same grayscale value.

To address the luminance drop, the grayscale value of the image frame may be compensated (or adjusted) based on the accumulated stress, and the pixel may be driven using the compensated grayscale value. Accordingly, the pixel may output a desired level of luminance. For example, as the accumulated stress increases, the compensation value added to the gradation value of the image frame may increase as shown by the arrows in FIG. 2. In this case, even if a pixel deteriorates, the pixel may output a desired level of luminance as shown in the dotted line of FIG. 2.

The accumulated stress may be related to the gradation values displayed by the pixel. For example, grayscale values of image data displayed by each pixel may be continuously monitored, and the grayscale values displayed by the pixel may be accumulated. Accumulated stress may be estimated based on the accumulated data.

The accumulated data may be loaded into a working memory such as random-access-memory (RAM) and continuously updated based on the image data. The accumulated data in the working memory may be periodically stored (or backed up) in a non-volatile storage medium such as flash memory.

Referring back to FIG. 1, the display device 100 may further include a bus system 150 (e.g., a data bus), a working memory 160, and a non-volatile memory 170.

The bus system 150 is configured to provide the timing controller 120 with an interface with the working memory 160 and the non-volatile memory 170. A degradation compensator 121 of the timing controller 120 may communicate with the working memory 160 and the non-volatile memory 170 via the bus system 150.

The deterioration compensator 121 may update accumulated stress data corresponding to the pixels PX of the display panel 110 to the working memory 160 based on a reference image frame.

The accumulated stress data stored in working memory 160 may be stored and/or updated in non-volatile memory 170, e.g., every predetermined time period.

The reference image frame may be a modified image frame provided by the degradation compensator 121. However, embodiments are not limited thereto. For example, the reference image frame may be an image frame generated by performing additional processes on the modified image frame. As another example, the reference image frame may be an output image frame OFR. As another example, the reference image frame may be an input image frame IFR.

According to the accumulated stress data, the degradation compensator 121 may perform compensation on the input image frame IFR to output a modified image frame.

In embodiments, the working memory 160 may include at least one of memories such as RAM, DRAM (Dynamic RAM), SRAM (Static RAM), SDRAM (Synchronous Dynamic RAM), or DDR SDRAM (Double Data Rate Synchronous Dynamic Random Access Memory).

In embodiments, the non-volatile memory 170 may include at least one of storage media, such as flash memory, that maintains data even when powered off.

In embodiments, the timing controller 120, bus system 150, working memory 160, and non-volatile memory 170 may be mounted on the control board CB of FIG. 1. The timing controller 120 may be connected to other components of the display device 100 such as the scan driver 130, the data driver 140, and the display panel 110 through input/output interfaces (e.g., signal pads) of the control board CB. In embodiments, the control board CB may further include at least a portion of the scan driver 130 and the data driver 140.

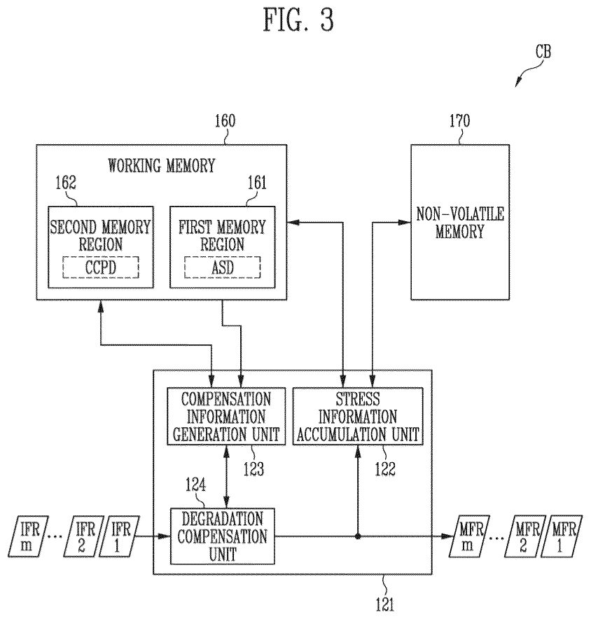

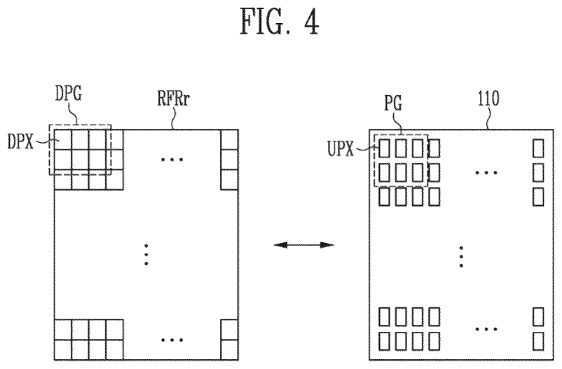

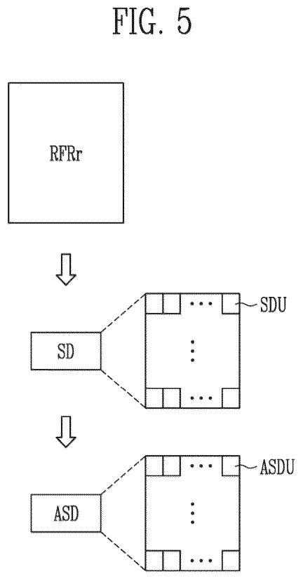

FIG. 3 is a block diagram illustrating an embodiment of the control board CB of FIG. 1. FIG. 4 is a diagram conceptually illustrating pixel groups of the display panel of FIG. 1 and data pixel groups of a reference image frame. FIG. 5 is a diagram conceptually illustrating processes of updating accumulated stress data based on a reference image frame.

Referring to FIGS. 1 and 3, the control board CB may include a degradation compensator 121, a working memory 160, and a non-volatile memory 170.

The degradation compensator 121 (e.g., a logic circuit) may include a stress information accumulation unit 122 (e.g., a first sub-logic circuit), a compensation information generation unit 123 (e.g., a second sub-logic circuit), and a degradation compensation unit 124 (e.g. a third sub-logic circuit). The stress information accumulation unit 122, the compensation information generation unit 123, and the deterioration compensation unit 124 may access the working memory 160 and the non-volatile memory 170 to write and read data.

The stress information accumulation unit 122 may operate in response to control of the deterioration compensation unit 124. The stress information accumulation unit 122 is configured to store accumulated stress data ASD in the working memory 160 and update the accumulated stress data ASD. The accumulated stress data ASD may indicate stresses (e.g., stress values) accumulated in the pixels PX of the display panel 110.

The stress information accumulation unit 122 may update the accumulated stress data ASD based on a reference image frame. In embodiments, the reference image frame may be any one of first to m-th modified image frames MFR1 to MFRm. In other embodiments, the reference image frame may be any one of first to m-th input image frames IFR1 to IFRm.

Referring to FIG. 4, the display panel 110 may include a plurality of unit pixels UPX. Each of the unit pixels UPX may be a sub-pixel such as a red sub-pixel, a green sub-pixel, and a blue sub-pixel. The unit pixels UPX may be the pixels PX of FIG. 1. The unit pixels UPX may be grouped into pixel groups. For example, a pixel group PG may include six unit pixels UPX. However, embodiments are not limited thereto. The pixel group PG may include more or fewer than six unit pixels UPX. For example, the pixel group PG may include one unit pixel.

An r-th reference image frame RFRr may include a plurality of data pixels DPX (r is an integer greater than or equal to 1 and less than or equal to m). It may be understood that the unit pixels UPX are respectively driven according to the data pixels DPX. The data pixels DPX may be grouped into data pixel groups. For example, when one pixel group PG includes six unit pixels UPX, one data pixel group DPG may include six data pixels DPX.

Referring to FIG. 5 together with FIG. 4, the stress information accumulation unit 122 (see FIG. 3) may generate stress data SD corresponding to the display panel 110 based on the r-th reference image frame RFRr. The stress data SD may include stress data units SDU respectively corresponding to pixel groups of the display panel 110.

Each stress data unit may be generated based on a corresponding data pixel group DPG (see FIG. 4). Each stress data unit may represent at least one stress value. The stress value of the stress data unit may be determined according to an average of the grayscale values of the data pixels DPX (see FIG. 4) included in the corresponding data pixel group DPG. For example, the stress value of the stress data unit may include an average value of grayscale values of red data pixels among the six data pixels DPX, an average value of greyscale values of green data pixels among the sixth data pixels DPX and an average value of the grayscale values of blue data pixels of the six data pixels DPX. As such, the stress data units SDU may be generated based on each of the data pixel groups.

The stress information accumulation unit 122 may update the accumulated stress data ASD according to the stress data SD. The accumulated stress data ASD may include accumulated stress data units ASDU respectively corresponding to pixel groups of the display panel 110.

The accumulated stress data units ASDU may be updated based on the stress data units SDU, respectively. Each accumulated stress data unit may represent an accumulated stress value. In embodiments, the accumulated stress value of the accumulated stress data unit may be updated to a value obtained by adding the stress value of the stress data unit to the existing accumulated stress value. For example, each stress data unit may include eight data bits corresponding to red, eight data bits corresponds to green, and eight data bits correspond to blue. Each accumulated stress data unit may include 42 data bits corresponding to red, 42 data bits corresponds to green, and 42 data bits correspond to blue. In this case, by adding the accumulated stress value of the 42 data bits corresponding to each color to the stress value of the corresponding 8 data bits, the corresponding 42 data bits will be updated. Accordingly, the 42 data bits corresponding to red, the 42 data bits corresponds to green, and the 42 data bits correspond to blue may be updated. For example, if the accumulated stress data unit initially stores 42-bit values of 100,000 for red, 120,000 for green, and 150,000 for blue, and a new stress data unit generated based on the reference image frame RFRr provides 8-bit values of 50 for red, 70 for green, and 80 for blue, then the updated accumulated stress values would be 100,050 for red, 120,070 for green, and 150,080 for blue, respectively, by adding each 8-bit stress value to its corresponding 42-bit accumulated value.

In this way, the stress information accumulation unit 122 may update the accumulated stress data ASD for the unit pixels UPX of the display panel 110 based on the reference image frame RFRr.

In embodiments, the stress information accumulation unit 122 may update accumulated stress datasets for a portion of the unit pixels UPX based on a portion of the reference image frame RFRr. For example, the stress information accumulation unit 122 may sequentially update the accumulated stress data sets corresponding to the portions of the unit pixels UPX based on each of the plurality of reference image frames. The accumulated stress data sets corresponding to portions of the pixels PX may be understood to form accumulated stress data ASD corresponding to all of the unit pixels UPX. As such, the accumulated stress data ASD corresponding to the unit pixels UPX may be updated based on the plurality of reference image frames.

Referring back to FIG. 3, the compensation information generation unit 123 and the degradation compensation unit 124 are configured to correct (or modify) the input image frame to generate a modified image frame based on the accumulated stress data ASD. The first to m-th input image frames IFR1 to IFRm may be corrected to generate the first to m-th modified image frames MFR1 to MFRm, respectively.

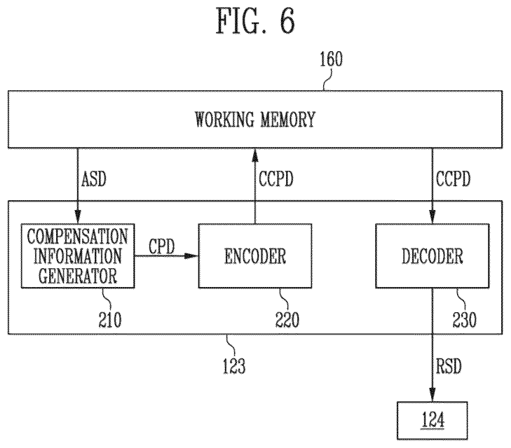

The compensation information generation unit 123 may operate in response to the control of the deterioration compensation unit 124. The compensation information generation unit 123 may access the working memory 160. The compensation information generation unit 123 may read the accumulated stress data ASD from the working memory 160, generate compressed compensation data CCPD based on the read accumulated stress data ASD, and store the generated compressed compensation data CCPD in the working memory 160. This will be explained in more detail with reference to FIG. 6.

The compensation information generation unit 123 may read the compressed compensation data CCPD from the working memory 160, decode the read compressed compensation data CCPD to restore the compensation data, and provide the restored compensation data to the deterioration compensation unit 124.

The degradation compensation unit 124 is configured to generate first to m-th modified image frames MFR1 to MFRm by modifying the first to m-th input image frames IFR1 to IFRm based on the restored compensation data. Each of the first to m-th input image frames IFR1 to IFRm may correspond to the input image frame IFR of FIG. 1.

In embodiments, the timing controller 120 (see FIG. 1) may further include at least one processor to perform additional compensation operations on each modified image frame to generate an output image frame OFR of FIG. 1. The timing controller 120 provides an output image frame OFR to the data driver 140 (see FIG. 1) to display an image on the display panel 110.

In embodiments, at least some of the stress information accumulation unit 122, the compensation information generation unit 123, and the degradation compensation unit 124 may be integrated or separated into more components. In embodiments, each of the stress information accumulation unit 122, the compensation information generation unit 123, and the degradation compensation unit 124 may be implemented in hardware, software, firmware, and combinations thereof.

The working memory 160 may include a first memory region 161 and a second memory region 162. Accumulated stress data ASD may be stored in the first memory region 161, and compressed compensation data CCPD may be stored in a second memory region 162.

In an embodiment, the operations of the compensation information generation unit 123 updating the compressed compensation data CCPD do not overlap in time with the operations of the stress information accumulation unit 122 updating the accumulated stress data ASD. This control may be performed by the deterioration compensation unit 124. Accordingly, the input/output bandwidth required for the communication channels between the first and second memory regions 161 and 162 and the degradation compensator 121 should not increase. In embodiments, the first and second memory regions 161 and 162 may be physically separated from each other. In other embodiments, the first and second memory regions 161 and 162 may be integrated into one memory, in which case the first and second memories 161 and 162 may be logically separated.

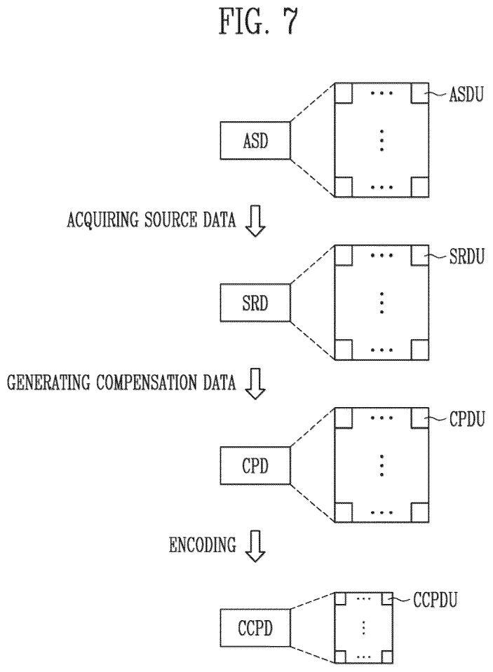

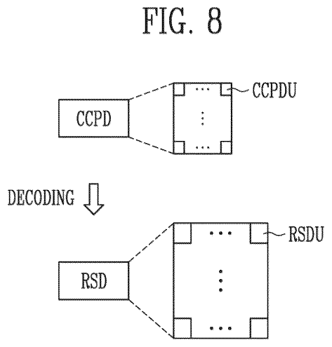

FIG. 6 is a block diagram illustrating an embodiment of the compensation information generation unit of FIG. 3. FIG. 7 is a diagram conceptually illustrating processes of generating compressed compensation data from accumulated stress data in the compensation information generation unit of FIG. 6. FIG. 8 is a diagram conceptually illustrating processes of restoring compensation data from compressed compensation data in the compensation information generation unit of FIG. 6.

Referring to FIGS. 3 and 6, the compensation information generator 123 (e.g., a logic circuit) may include a compensation information generator 210 (e.g., a first sub-logic circuit), an encoder 220 (e.g., a second sub-logic circuit), and a decoder 230 (e.g., a third sub-logic circuit).

The compensation information generator 210 may read the accumulated stress data ASD from the working memory 160 and generate compensation data CPD according to the accumulated stress data ASD. The encoder 220 may encode the compensation data CPD to generate compressed compensation data CCPD, and store the resulting compressed compensation data CCPD in the working memory 160. Compared to the case where the compensation data CPD is stored in the working memory 160, the input/output bandwidth required for the communication channel between the degradation compensator 121 and the working memory 160 may be reduced when the compressed compensation data CCPD is stored in a working memory 160.

Referring to FIG. 7 along with FIG. 6, the compensation information generator 210 extracts source data units SRDU from the accumulated stress data units ASDU of the accumulated stress data ASD, respectively. The extracted source data units SRDU may constitute source data SRD. The compensation information generator 210 may then selectively process the source data units SRDU of the source data SRD to generate compensation data units CPDU, respectively. The compensation data units CPDU may constitute compensation data CPD. According to an embodiment of the present disclosure, the compensation information generator 210 converts the source data units SRDU to generate compensation data units CPDU such that the restoration data RSD is similar (or identical) to the compensation data CPD. The compensation data units CPDU may be understood to correspond to the accumulated stress data units ASDU, respectively.

The encoder 220 may encode the compensation data CPD to generate compressed compensation data CCPD. The compressed compensation data CCPD may have a smaller size than the compensation data CPD. The compressed compensation data CCPD may include compressed compensation data units CCPDU. The compressed compensation data units CCPDU may respectively correspond to compensation data units CPDU. The number of the compressed compensation data units CCPDU may be the same as the number of the compensation data units CPDU, and the size of one compressed compensation data unit may be smaller than the size of one compensation data unit. However, embodiments are not limited thereto. The data format of the compressed compensation data CCPD may vary depending on the encoding algorithm used by the encoder 220. For example, the number of the compressed compensation data units CCPDU may be smaller than the number of compensation data units CPDU.

The compensation information generator 210 and encoder 220 may periodically generate and update the compressed compensation data CCPD based on accumulated stress data ASD according to the above processes.

In an embodiment, the encoder 220 encodes compensation data units CPDU based on a Differential Pulse Code Modulation (DPCM) algorithm. For example, the encoder 220 may determine the difference between the value of the compensation data unit and the value of at least one adjacent compensation data unit, and use this difference as the value of the corresponding compressed compensation data unit. In this case, when the difference between the value of the compensation data unit and the value of the adjacent compensation data unit is relatively small, the value of the compressed compensation data unit may be relatively small. In other words, when the correlation between the compensation data unit and adjacent the compensation data unit is relatively large, the value of the compressed compensation data unit may be relatively small. When the difference between the value of the compensation data unit and the value of the adjacent compensation data unit is relatively large, the value of the compressed compensation data unit may be relatively large. In other words, when the correlation between the compensation data unit and the adjacent compensation data unit is relatively small, the value of the compressed compensation data unit may be relatively large. When the difference between the value of the compensation data unit and the value of the adjacent compensation data unit is relatively large, the DPCM algorithm may adjust the value of the compression compensation data unit according to the size (or the number of data bits) allowed for the compression compensation data units. For example, the value of the compressed compensation data unit may be adjusted to be smaller than the difference between the value of the compensation data unit and that of at least one adjacent compensation data unit.

Referring back to FIGS. 3 and 6, the decoder 230 may read the compressed compensation data CCPD stored in the working memory 160, and decode the read compressed compensation data CCPD to generate restored compensation data RSD (hereinafter, referred to as restoration data). In embodiments, the decoder 230 may decode compressed compensation data CCPD based on the DPCM algorithm.

Referring to FIG. 8, the compression compensation data CCPD may be decoded to generate the restoration data RSD. The restoration data RSD may include a plurality of restoration data units RSDU. The restoration data units RSDU may correspond to the compensation data units CPDU of FIG. 7, respectively. The restoration data units RSDU should be the same as or similar to compensation data units CPDU. If the restoration data units RSDU are not similar to the compensated data units CPDU, it indicates that a significant amount of information from the compensated data unit CPDU was lost during the encoding and decoding processes.

Referring back to FIGS. 3 and 6, the decoder 230 may provide the restoration data RSD to the degradation compensation unit 124. The degradation compensation unit 124 is configured to modify the first to m-th input image frames IFR1 to IFRm to generate the first to m-th modified image frames MFR1 to MFRm, respectively, based on the restoration data RSD.

The display panel 110 (see FIG. 1) gradually deteriorates as the image is displayed, and accordingly the values of the accumulated stress data units ASDU (see FIG. 7) may increase. As the value of the accumulated stress data unit increases, the value of the corresponding source data unit may increase, which means that the complexity of the source data units SRDU increases.

As the complexity of the source data unit increases, the correlation between the source data unit and the adjacent source data unit decreases probabilistically. For example, if a specific display area in the display panel 110 repeatedly displays the same image, that area may become relatively more degraded over time. In this case, the source data unit corresponding to the specific display area may exhibit a relatively greater complexity compared to those other display areas, indicating lower correlation between that unit and source data units from less degraded regions.

If the source data units SRDU are provided as compensation data units CPDU as is, and the encoder 220 employs the DPCM algorithm to encode the source data units SDU, the reliability of the compressed compensation data units CCPDU may be relatively low. Due to the limited size (or number of data bits) of each compression compensation data unit, the value of the compression compensation data unit may be adjusted. For example, the value of the compression compensation data unit may be adjusted to differ from the exact difference between the value of the source data unit and that of an adjacent source data unit. In this case, the restoration data units may not be similar to the source data units SRDU. When the size of each compression compensation data unit, the resources allocated to the encoder 220 and the decoder 230, and the like are relatively low, this phenomenon may be more pronounced. In other words, a significant amount of information from the source data units SRDU may be lost during the encoding and decoding processes, resulting in restoration data units that differ noticeably from the original source data units.

According to an embodiment of the present disclosure, the compensation information generator 210 changes one or more least significant data bits of the data bits of each source data unit to a first logic level (e.g., a logic level low) according to a representative value corresponding to the source data units SRDU. For example, a data bit having a second logic level among the corresponding least significant data bits may be changed to the first logic level. The data bit having the first logic level among the corresponding least significant data bits may be maintained at the first logic level. For example, if a 10-bit source data unit has a binary value of 0110110110, and the representative value indicates that two least significant bits should be changed, then the two rightmost bits (10) are examined. In this case, the least significant bit (0) already has the first logic level (e.g., logic low), so it is left unchanged, while the next bit (1) is changed to 0. As a result, the modified compensation data unit becomes 0110110100.

The representative value may be a value indicating complexity of the source data units SRDU. The modified source data units SRDU may be provided as compensation data units CPDU. Accordingly, the complexity of the compensation data units CPDU may be lower than the source data units SRDU. As the complexity of the compensation data units CPDU decreases, the restoration data RSD may be substantially the same as or similar to the compensation data CPD. In addition, since the least significant data bit is changed, the value of each compensation data unit may be different from the value of the corresponding source data unit by a relatively small value. This may mean that the value of each compensation data unit efficiently reflects the value of the source data unit. Consequently, the restoration data RSD may be substantially the same as or at least similar to the compensation data CPD. Accordingly, the modified image frames MFR1 to MFRm generated based on the restoration data RSD may have enhanced reliability, and the image displayed on the display panel 110 may have enhanced reliability. For example, an afterimage may not be recognized in the image displayed on the display panel 110.

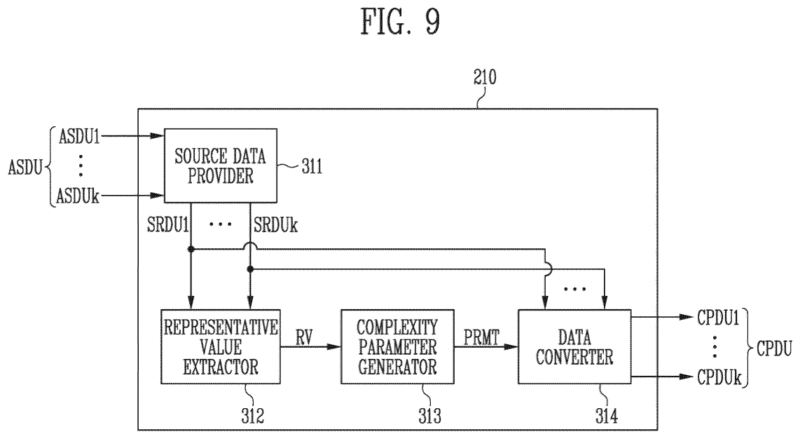

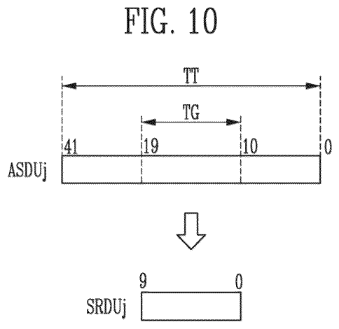

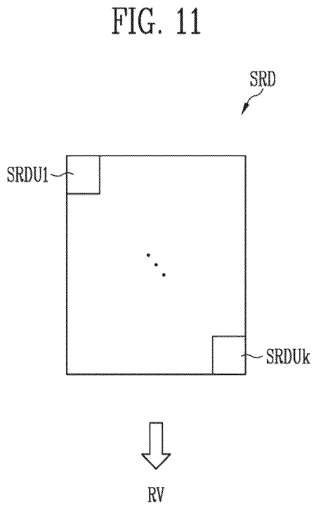

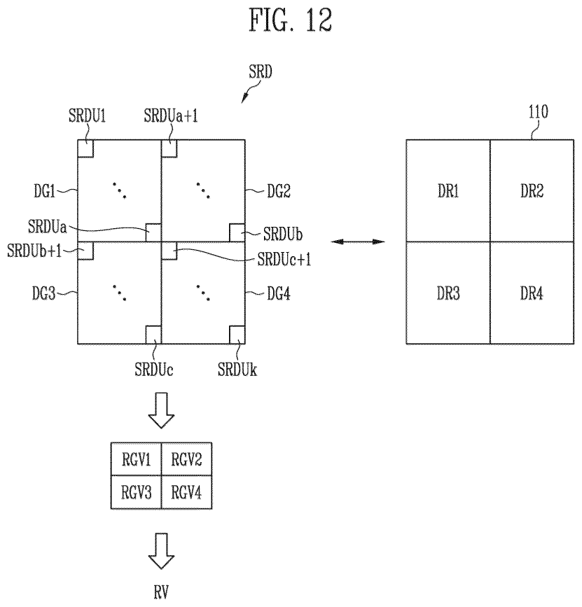

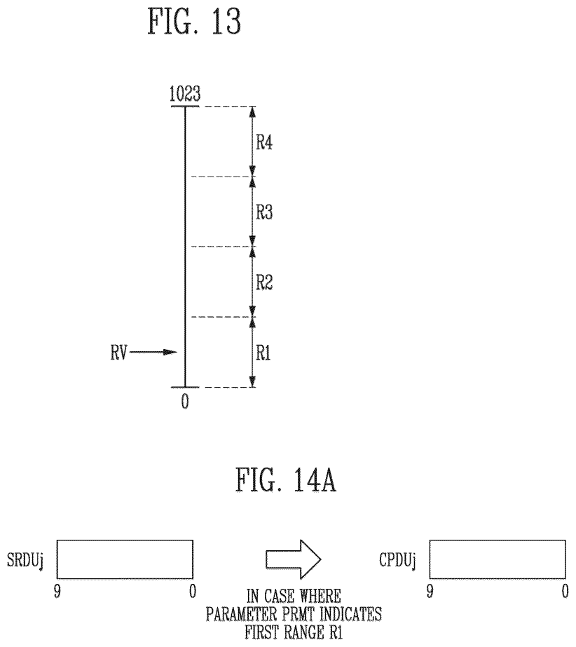

FIG. 9 is a block diagram illustrating an embodiment of the compensation information generator of FIG. 6. FIG. 10 is a conceptual diagram illustrating an accumulated stress data unit and a source data unit extracted therefrom. FIGS. 11 and 12 are diagrams for illustrating embodiments of a method of determining a representative value of source data units. FIG. 13 is a diagram conceptually illustrating a plurality of ranges to which a representative value may belong. FIGS. 14A to 14D are diagrams conceptually illustrating a compensation data unit generated according to a representative value.

Referring first to FIG. 9, the compensation information generator 210 receives the first to k-th accumulated stress data units ASDU1 to ASDUk (k is an integer greater than 1). Based on the first to k-th accumulated stress data units ASDU1 to ASDUk, the compensation information generator 210 may generate the first to k-th compensation data units CPDU1 to CPDUk. The first to k-th accumulated stress data units ASDU1 to ASDUk may be included in the accumulated stress data units ASDU of FIG. 7. The first to k-th compensation data units CPDU1 to CPDUk may be included in the compensation data units CPCU of FIG. 7.

The compensation information generator 210 (e.g., a logic circuit) may include a source data provider 311 (e.g., a first sub-logic circuit), a representative value extractor 312 (e.g., a second sub-logic circuit), a complexity parameter generator 313 (e.g., a third sub-logic circuit), and a data converter 314 (e.g., a fourth sub-logic circuit).

The source data provider 311 receives the first to k-th accumulated stress data units ASDU1 to ASDUk. The source data provider 311 may extract some data bits of each accumulated stress data unit as a source data unit. Referring to FIG. 10, a j-th accumulated stress data unit ASDUj may include a plurality of data bits TT (j is an integer greater than or equal to 1 and less than or equal to k). For example, the j-th accumulated stress data unit ASDUj may include a total of 42 data bits TT of [41:0]. Data bits between the least significant data bits and the most significant data bits of the entire data bits TT of the j-th accumulated stress data unit ASDUj may be defined as the target data bits TG. Depending on the target data bits TG, a j-th source data unit SRDUj may be determined. For example, 10 data bits of [19:10] out of the total data bits TT of the j-th accumulated stress data unit ASDUj may be extracted as target data bits TG, and the target data bits TG may be determined to be the j-th source data unit SRDUj of [9:0]. In addition, at least one of various algorithms may be employed to determine the j-th source data unit SRDUj from the target data bits TG. As such, the first to k-th source data units SRDU1 to SRDUk may be determined according to the first to k-th accumulated stress data units ASDU1 to ASDUk, respectively.

Referring back to FIG. 9, the representative value extractor 312 receives the first to k-th source data units SRDU1 to SRDUk. The representative value extractor 312 may generate a representative value RV according to the values of the first to k-th source data units SRDU1 to SRDUk. The representative value RV may be understood to indicate the complexity of the first to k-th source data units SRDU1 to SRDUk.

Referring to FIG. 11, first to k-th source data units SRDU1 to SRDUk are shown. The maximum value among the values of the first to k-th source data units SRDU1 to SRDUk may be determined as the representative value RV. For example, according to 10 data bits of [9:0] of each source data unit, the value of the source data unit may be determined. The maximum value among the determined values of the first to k-th source data units SRDU1 to SRDUk may be determined as the representative value RV. However, embodiments are not limited thereto. For example, an average value of values of the first to k-th source data units SRDU1 to SRDUk may be determined as a representative value RV. For example, assume five source data units SRDU1 to SRDU5 have 10-bit values of 0011001100 (204 ), 0100101001 (297), 0001110000 (112), 0110110110 (438), and 0011011011 (219), respectively. If the representative value RV is determined as the maximum among these values, then RV is 438. Alternatively, if RV is determined as the average of the source data unit values, then RV is (204+297+112+438+219)÷5=254.

Referring to FIG. 12, pixels of the display panel 110 may be logically or conceptually divided into first to fourth display areas DR1 to DR4. The first to k-th source data units SRDU1 to SRDUk may be divided into first to fourth data groups DG1 to DG4. The first data group DG1 includes first to a-th source data units SRDU1 to SRDUa (a is an integer greater than 1 and less than k). The second data group DG2 includes a+1-th to b-th source data units SRDUa+1 to SRDUb (b is an integer greater than a+1 and less than k). The third data group DG3 includes b+1-th to c-th source data units SRDUb+1 to SRDUc (c is an integer greater than b+1 and less than k). The fourth data group DG4 includes c+10-th to k-th source data units SRDUc+1 to SRDUk (d is an integer greater than c+1 and less than k).

The first to fourth data groups DG1 to DG4 may correspond to the first to fourth display areas DR1 to DR4, respectively. For example, the first to fourth data groups DG1 to DG4 may be extracted from the accumulated stress data corresponding to the first to fourth display areas DR1 to DR4, respectively.

The first area value RGV1 is determined according to the values of the first to a-th source data units SRDU1 to SRDUa of the first data group DG1. The second area value RGV2 is determined according to the values of the a+1-th to b-th source data units SRDUa+1 to SRDUb of the second data group DG2. The third area value RGV3 is determined according to the values of the b+1-th to c-th source data units SRDUb+1 to SRDUc of the third data group DG3. The fourth area value RGV4 is determined according to the values of the c+1-th to k-th source data units SRDUc+1 to SRDUk of the fourth data group DG4. Then, the representative value RV may be determined according to the first to fourth area values RGV1 to RGV4. For example, an average value of values of the first to a-th source data units SRDU1 to SRDUa may be determined as the first area value RGV1, an average value of the values of the a+1-th to b-th source data unit SRDUa+1 to SRDUb may be determined as the second area value RGV2, an average value of values of the b+1-th to c-th source data units SRDUb+1 to SRDUc may be determined as the third area value RGV3, and an average value of values of the c+1-th to k-th source data units SRDUc+1 to SRDUk may be determined as the fourth area value RGV4. Then, a maximum value among the first to fourth area values RGV1 to RGV4 may be determined as the representative value RV.

For example, assume there are 12 source data units SRDU1 to SRDU12 divided into four data groups: DG1 includes SRDU1 to SRDU3 with values 120, 140, and 160; DG2 includes SRDU4 to SRDU6 with values 200, 210, and 190; DG3 includes SRDU7 to SRDU9 with values 100, 110, and 120; and DG4 includes SRDU10 to SRDU12 with values 180, 170, and 160. The area values are calculated as follows: RGV1=(120+140+160)/3=140, RGV2=(200+210+190)/3=200, RGV3=(100+110+120)/3=110, and RGV4=(180+170+160)/3=170. The representative value RV is then determined as the maximum of these area values, which is 200.

In addition, the representative value RV may be determined according to the values of the first to k-th source data units SRDU1 to SRDUk using at least one of various manners, as long as the representative value RV represents the complexity of the first to the k-th source data units SRDU1 to SRDUk.

Referring back to FIG. 9, the complexity parameter generator 313 may output a parameter PRMT indicating the complexity of the first to k-th source data units SRDU1 to SRDUk according to the representative value RV. The parameter PRMT is provided to the data converter 314. The representative value RV may fall within a determined numerical range. Referring to FIG. 13, for example, when each source data unit includes 10 data bits of [9:0], the representative value RV may be any one of 0 to 1023. The determined numerical range may be divided into multiple ranges. For example, the determined numerical range may be divided into first to fourth ranges R1 to R4, with a second range R2 being greater than the first range R1, a third range R3 being greater than the second range R2, and a fourth range R4 being greater than the third range R3. Here, the parameter PRMT may represent any one of the first to fourth ranges R1 to R4. In other words, the parameter PRMT may indicate a range to which the representative value RV belongs among the first to fourth ranges R1 to R4.

Referring back to FIG. 9, the data converter 314 receives the first to k-th source data units SRDU1 to SRDUk and the parameter PRMT. The data converter 314 may change one or more least significant data bits of the data bits of a j-th source data unit SRDUj to a first logic level according to the parameter PRMT to generate a j-th compensation data unit CPDUj. Similarly, the data converter 314 may change the least significant data bits of the other source data units SRDU1 to SRDUj−1 and SRDUj+1 to SRDUk according to the parameter PRMT to generate the other compensation data units CPDU1 to CPDUj−1 and CPDUj+1 to CPDUk, respectively.

Referring to FIG. 14A, when the parameter PRMT indicates the first range R1 of the first to fourth ranges R1 to R4, the j-th source data unit SRDUj may be provided as the j-th compensation data unit CPDU1 without change. For example, assume the source data unit SRDUj is a 10-bit binary value 1011011011 (decimal 731). When the representative value RV falls within the first range R1, as shown in FIG. 14A, the parameter PRMT indicates no modification is needed, so the compensation data unit CPDUj remains 1011011011 or unchanged.

As the range indicated by the parameter PRMT increases, the number of least significant data bits that are changed to the first logic level may increase. Referring to FIG. 14B, when the parameter PRMT indicates the second range R2, the least significant data bit of the j-th source data unit SRDUj may be changed to a logic level low to generate the j-th compensation data unit CPDUj. For example, when RV falls within the second range R2, as in FIG. 14B, PRMT indicates that the least significant bit (LSB) should be changed to logic low. Since the original LSB is 1, it is changed to 0, resulting in 1011011010 (CPDUj=730).

Referring to FIG. 14C, when the parameter PRMT indicates the third range R3, the two least significant data bits of the j-th source data unit SRDUj may be changed to the logic level low to generate the j-th compensation data unit CPDUj. In FIG. 14C, where RV falls in the third range R3, PRMT indicates that the two least significant bits should be set to logic low. The original LSBs 11 are changed to 00, yielding 1011011000 (CPDUj=728).

Referring to FIG. 14D, when the parameter PRMT indicates the fourth range R4, the three least significant data bits of the j-th source data unit SRDUj may be changed to the logic level low to generate the j-th compensation data unit CPDUj. In FIG. 14D, where RV falls in the fourth range R4, PRMT indicates that the three least significant bits should be changed to logic low. Changing 011 to 000 produces 1011011000 (still CPDUj=728 in this case, due to the original third LSB already being 0).

In other embodiments, the complexity parameter generator 313 may be omitted and the data converter 314 may receive the representative value RV instead of the parameter PRMT. In this case, the data converter 314 may increase the number of least significant data bits that change to the first logic level in each source data unit as the representative value RV increases.

The parameter PRMT indicating a relatively low range (e.g., R1) may mean that a relatively large number of most significant data bits of the first to k-th source data units SRDU1 to SRDUk are logic level low. This may mean that the first to k-th source data units SRDU1 to SRDUk have low complexity and have high correlation with each other. In this case, the first to k-th source data units SRDU1 to SRDUk may be provided as the first to k-th compensation data units CPDU1 to CPDUk without change. Accordingly, the first to k-th compensation data units CPDU1 to CPDUk may reflect the accumulated stress as much as possible.

The parameter PRMT indicating a relatively high range (e.g., R4) may mean that fewer of the most significant data bits among the first to k-th source data units SRDU1 to SRDUk are at a logic level low. This may mean that the first to k-th source data units SRDU1 to SRDUk have high complexity and have low correlation with each other. In this case, the least significant data bits of the first to k-th source data units SRDU1 to SRDUk may be changed to a logic level low according to the parameter PRMT to provide the first to k-th compensation data units CPDU1 to CPDUk. Thus, the correlation of the first to k-th compensation data units CPDU1 to CPDUk may be higher than the correlation of the first to k-th source data units SRDU1 to SRDUk. The increased correlation may enhance the reliability of encoding and decoding operations. In addition, since only the least significant data bits are changed, the value of each compensation data unit may differ from its corresponding source data unit by a relatively small amount. Consequently, the restoration data RSD (see FIG. 6) may be substantially the same as or at least similar to the compensation data CPD (see FIG. 6). Accordingly, the modified image frames MFR1 to MFRm (see FIG. 3) generated based on the restoration data RSD may have enhanced reliability.

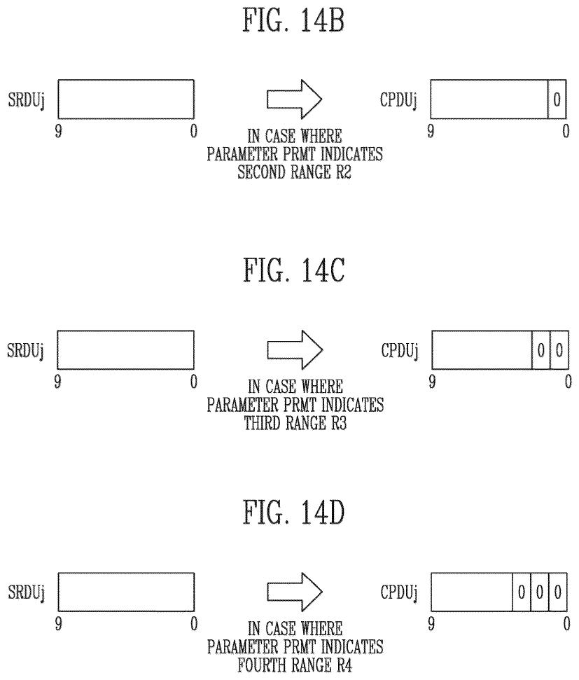

FIG. 15 is a block diagram illustrating an embodiment of the deterioration compensation unit of FIG. 3.

Referring to FIGS. 3 and 15, the degradation compensation unit 124 may perform compensation on the p-th data pixel DPXp included in the input image frame IFR to output the p-th data pixel DPXp′ of the modified image frame MFR. The input image frame IFR may be any one of the first to m-th input image frames IFR1 to IFRm. The p-th data pixel DPXp may be one of the data pixels (see DPX in FIG. 4) of the input image frame IFR. The modified image frame MFR may be any one of the first to m-th modified image frames MFR1 to MFRm. The p-th data pixel DPXp′ may be one of the data pixels of the modified image frame MFR.

The degradation compensation unit 124 may include at least one look-up table LUT. In other embodiments, the look-up table LUT may be loaded into the working memory 160, and the degradation compensation unit 124 may access the working memory 160 to read the look-up table LUT.

The degradation compensation unit 124 obtains a q-th restoration data unit RSDUq corresponding to a p-th data pixel DPXp from among the restoration data units RSDU (q is an integer greater than or equal to 1 and less than or equal to k). The q-th restoration data unit RSDUq may correspond to a data pixel group DPG (see FIG. 5) to which the p-th data pixel DPXp belongs among the restoration data units RSDU. The q-th restoration data unit RSDUq may be provided from the compensation information generation unit 123.

The degradation compensation unit 124 may obtain a compensation value corresponding to the q-th restoration data unit RSDUq from the lookup table LUT. The deterioration compensation unit 124 may determine the p-th data pixel DPXp′ of the modified image frame MFR by reflecting the obtained compensation value in the grayscale value of the p-th data pixel DPXp. For example, the compensation value is added to the grayscale value of the p-th data pixel DPXp of the input image frame IFR, so that the p-th data pixel DPXp′ of the modified image frame MFR may be determined. For example, assume the grayscale value of the p-th data pixel DPXp in the input image frame IFR is 150, and the corresponding compensation value derived from the restoration data is 20. By adding the compensation value to the original grayscale value, the modified pixel value DPXp′ in the modified image frame MFR becomes 170 (i.e., 150+20=170).

In this way, the deterioration compensation unit 124 may perform compensation on the data pixels of the input image frame IFR to generate the modified image frame MFR.

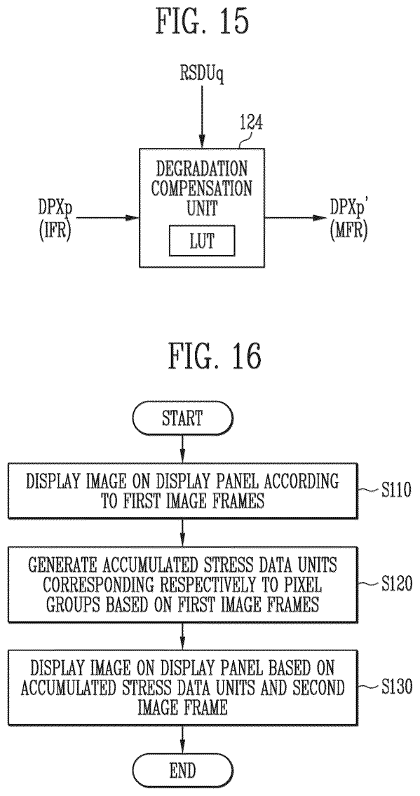

FIG. 16 is a flowchart illustrating a method of operating a display device according to an embodiment.

Referring to FIGS. 1 and 16, in step S110, the display device 100 displays an image on the display panel 110 according to the first image frames.

In step S120, the display device 100 may generate accumulated stress data units (see ASDU in FIG. 5) respectively corresponding to the pixel groups (see DPG in FIG. 4) based on the first image frames.

In step S130, the display device 100 may display an image on the display panel based on the accumulated stress data units and the second image frame.

Each of the first image frames and the second image frame may be a modified image frame output from the degradation compensator 121. However, embodiments are not limited thereto. For example, each of the first image frames and the second image frame may be provided with a modified image frame further processed. As another example, each of the first image frames and the second image frame may be an input image frame IFR. As another example, each of the first image frames and the second image frame may be an output image frame OFR provided to the data driver 140.

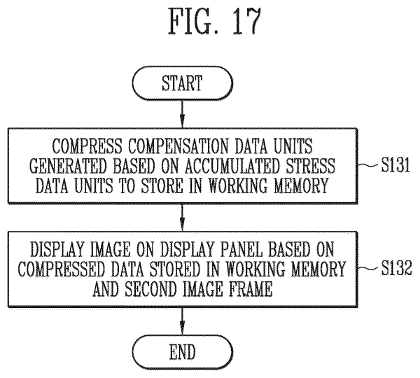

FIG. 17 is a flowchart illustrating an embodiment of step S130 of FIG. 16.

Referring to FIGS. 1 and 17, in step S131, the display device 100 compresses the compensation data units generated based on the accumulated stress data units and stores the compressed compensation data units in the working memory 160.

In step S131, the display device 100 may display an image on the display panel 110 based on the compressed data stored in the working memory 160 and the second image frame.

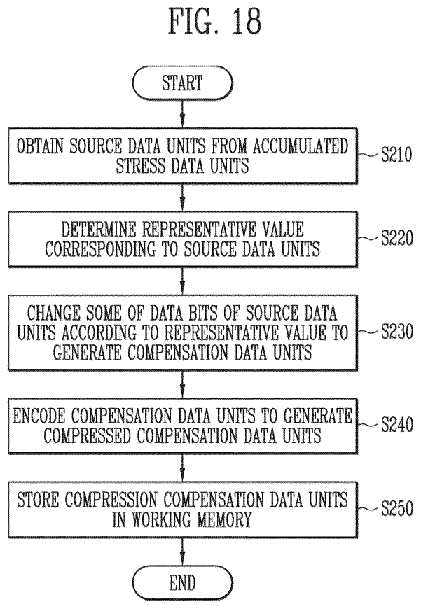

FIG. 18 is a flowchart illustrating an embodiment of step S131 of FIG. 17.

Referring to FIG. 1 and FIG. 18, in step S210, source data units SRDU (see FIG. 7) are obtained from the accumulated stress data units ASDU (see FIG. 7). The source data unit may be determined according to certain data bits of the data bits of each accumulated stress data unit. For example, certain data bits between the least significant data bits and the most significant data bits of the accumulated stress data unit may be determined as the source data unit.

In step S220, a representative value corresponding to the source data units SRDU is determined. A representative value may be determined according to the values of the source data units SRDU. In embodiments, as described with reference to FIG. 11, a maximum value of values of the source data units SRDU may be determined as a representative value. In other embodiments, as described with reference to FIG. 12, the pixels PX are grouped into a plurality of display areas, and an average value of values of source data units corresponding to each display area may be determined as an area value corresponding to the display area. According to the area values corresponding to the display areas, a representative value may be determined.

In step S230, some data bits of the source data units SRDU are changed according to the representative value to generate the compensation data units CPDU (see FIG. 7). Depending on the representative value, each compensation data unit may be generated by changing one or more least significant data bits of a corresponding source data unit to the first logic level. When the representative value is the first value, by changing the w least significant data bits of each source data unit to the first logical level, the corresponding compensation data unit may be generated (w is an integer greater than or equal to 0). When the representative value is a second value greater than the first value, by changing the z least significant data bits of each source data unit to the first logical level, the corresponding compensation data unit may be generated (z is an integer greater than w).

In step S240, the compensation data units CPDU are encoded to generate compressed compensation data units CCPDU (see FIG. 7). In embodiments, by encoding the compensation data units CPDU based on the DPCM algorithm, the compressed compensation data units CCPDU may be generated. For example, a difference between a value of a compensation data unit and a value of at least one compensation data unit adjacent thereto may be determined as a value of a compressed compensation data unit corresponding to the compensation data unit.

In step S250, the compression compensation data units CCPDU are stored in the working memory 160.

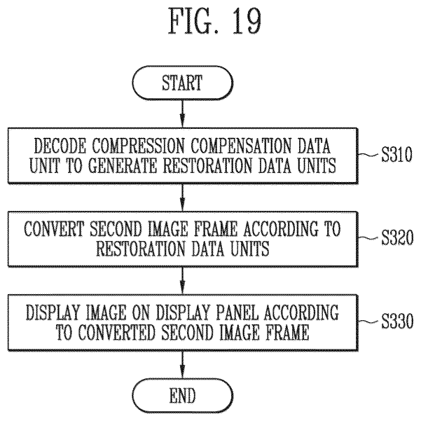

FIG. 19 is a flowchart illustrating an embodiment of step S132 of FIG. 17.

Referring to FIGS. 1 and 19, in step S310, the compression compensation data units CCPDU (see FIG. 8) are read from the working memory 160, and the compression compensation data unit CCPDU is decoded to generate the restoration data units RSDU (see FIG. 8). In embodiments, restoration data units RSDUs may be generated by decoding compressed compensation data units CCPDUs based on the DPCM algorithm.

In step S320, the second image frame is converted according to the restoration data units RSDU. Each of data pixels of the second image frame may be converted with reference to the corresponding restoration data unit.

In step S330, an image is displayed on the display panel according to the converted second image frame.

According to an embodiment of the present disclosure, one or more least significant data bits of the data bits of each source data unit may be changed to the first logic level according to the representative value corresponding to the source data units SRDU. In this case, the representative value may be a value indicating complexity of the source data units SRDU. The modified source data units SRDU may be provided as compensation data units CPDU. Accordingly, the complexity of the compensation data units CPDU may be lower than the source data units SRDU. As the complexity of the compensation data units CPDU decreases, the restoration data RSD may be substantially the same as or similar to the compensation data CPD. In addition, since only the least significant data bit is changed, the value of each compensation data unit may differ from that of the corresponding source data unit by a relatively small amount. This may mean that the value of each compensation data unit efficiently reflects the value of the source data unit. Consequently, the restoration data RSD may be substantially the same as or at least similar to the compensation data CPD. Accordingly, the modified image frames MFR1 to MFRm generated based on the restoration data RSD may have enhanced reliability, and the image displayed on the display panel 110 may have enhanced reliability.

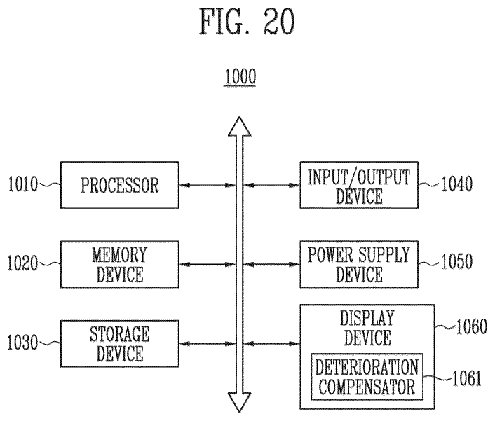

FIG. 20 is a block diagram illustrating a display system according to an embodiment.

Referring to FIG. 20, the display system 1000 may include a processor 1010, a memory device 1020, a storage device 1030, an input/output device 1040, a power supply device 1050, and a display device 1060. The display system 1000 may further include ports to communicate with other devices, such as video cards, sound cards, memory cards, USB devices, and the like.

The processor 1010 may perform various tasks and calculations. In embodiments, the processor 1010 may include an application processor, a graphics processing unit, a microprocessor, a central processing unit (CPU), or the like. The processor 1010 may be connected to other components of the display system 1000 via a bus system. In embodiments, the bus system may include a Peripheral Component Interconnect (PCI) bus. The processor 1010 may provide an image stream to be displayed on the display device 1060. The processor 1010 may further transmit the control signals CTRL of FIG. 1 to the display device 1060.

The memory device 1020 may be provided as a working memory and/or a buffer memory of the display system 1000 and/or the processor 1010. In embodiments, the memory device 1020 may include volatile memory devices such as dynamic random access memory (DRAM), static random access memory (SRAM), mobile DRAM, and the like.

The storage device 1030 may store data in response to control of the processor 1010. The storage device 1030 may include a non-volatile storage medium that retains data even when the display system 1000 is powered off. In embodiments, the storage device 1030 may include a Solid State Drive (SSD), a Hard Disk Drive (HDD), or the like.

In embodiments, at least a portion of the memory device 1020 may be provided in the working memory 160 of FIG. 1. At least a portion of the storage device 1030 may be provided in the non-volatile memory 170 of FIG. 1. In this case, portions of the memory device 1020 and the storage device 1030 may be mounted on, or disposed outside, the control board CB of FIG. 1.

The input/output device 1040 may include user input devices such as a keyboard, keypad, touchpad, touchscreen, mouse, etc., and output devices such as a speaker, printer, etc. The power supply device 1050 may supply power necessary for the operation of the display system 1000. For example, the power supply 1050 may include a battery.

The display device 1060 may display an image in response to the control of the processor 1010. The display device 100 of FIG. 1 may be provided as a display device 1060. The display device 1060 includes a deterioration compensator 1061, and the deterioration compensator 1061 may operate in the same manner as the deterioration compensators 121 of FIG. 1.

In embodiments, the display system 1000 may be a computer device or an electronic device including a display device 1060, such as a digital television, a 3D TV, a personal computer (PC), a home electronic device, a laptop computer, a tablet computer, a mobile phone, a smart phone, a personal digital assistant (PDA), a portable multimedia player (PMP), a digital camera, a music player, a portable game console, navigation, or the like.

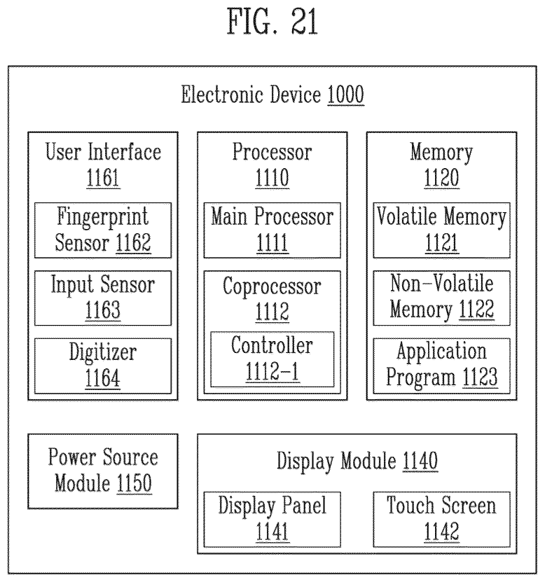

FIG. 21 is a diagram illustrating an electronic device according to an embodiment of the present invention. Referring to FIG. 21, the electronic device 1000 according to one embodiment of the present invention may output various information (e.g., images, text, music, etc.) through a display module 1140, which, for example, may correspond to the display device shown in FIG. 1. When a processor 1110 executes an application stored in a memory 1120, the display module 1140 may provide application information to a user through a display panel 1141. For example, the display module 1140 may be used to implement the display device 1060. For example, the memory 1120 may be used to implement the memory device 1020 or the storage device 1030. For example, the processor 1110 may be used to implement the processor 1010.

In some embodiments, the electronic device 1000 may be configured as a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 be an AR/VR headset.

In some embodiments, memory 1120 may store information such as software codes for operating an application program 1123. The application program 1123 may include a software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with the user interface 1161 or touch screen 1142, allowing a user to launch, navigate, and utilize the program through user inputs such as touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

As another example, when a user wishes to make a phone call, the user taps the telephone icon displayed on the display module 1140, the processor 1110 may execute a phone application program stored in the memory 1120. A telephone keypad may be presented on the display panel 1141 for the user to enter a phone number to call.

As another example, the display module 1140 may be integrated into an electronic device 1000, such as a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. For example, the touch screen 1142 may be included within the input/output device 1040. The display module 1140 may further include a window, a chassis, and a bracket to protect the display panel 1141. The display module 1140 may include at least a part of the configuration of the display device shown in FIG. 1.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164. For example, the fingerprint sensor 1162, the input sensor 1163, and a digitizer 1164 may be included within the input/output device 1040.

The fingerprint sensor 1162 may sense a fingerprint for biometric recognition of the user and may also measure one or more biological signals such as blood pressure, moisture, or body mass.

The input sensor 1163 may sense user interactions including touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display unit shown in FIG. 1.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140. For example, the power source module 1150 may be used to implement the power device 1050.

According to embodiments of the present disclosure, a display device, a method to operate the same, and a display system including the same having enhance reliability may be provided.

Although specific embodiments and applications have been described herein, other embodiments and variations may be derived from the above description. Accordingly, the invention is not limited to these embodiments, but extends to the claims, various obvious modifications, and equivalents set forth below.

What is claimed is:

1. A display device comprising:
a display panel comprising pixels;
a controller configured to control the display panel; and
a working memory connected to the controller,
wherein the controller is configured to:
update accumulated stress data corresponding to the pixels based on first image frames;
determine a representative value of source data units obtained from the accumulated stress data;
change a portion of data bits of each of the source data units according to the representative value, to generate changed source data units; and
encode the changed source data units to generate compressed data, and store the compressed data in the working memory.

2. The display device of claim 1, wherein the controller is configured to change one or more least significant data bits of the data bits of each of the source data units to a first logic level to generate the changed source data units.

3. The display device of claim 2, wherein a number of the least significant data bits changed to the first logic level is adjusted according to the representative value.

4. The display device of claim 2, wherein a number of the least significant data bits changed to the first logic level increases as the representative value increases.

5. The display device of claim 1, wherein the controller is configured maintain the source data units when the representative value is within a first range, and
wherein the controller is configured to change at least one least significant data bit of the data bits of each of the source data units to a first logic level when the representative value is within a second range greater than the first range.

6. The display device of claim 1, wherein the controller is configured to:
change n least significant data bits of the data bits of each of the source data units to a first logic level when the representative value is within a first range, where n is an integer greater than 1; and
change m least significant data bits of the data bits of each of the source data units to the first logic level when the representative value is within a second range greater than the first range, where m is an integer greater than n.

7. The display device of claim 1, wherein the controller is configured to convert a second image frame based on the compressed data when the second image frame is received, and
wherein an image is displayed on the display panel according to the converted second image frame.

8. The display device of claim 1, wherein, when a second image frame is received, the controller is configured to perform decoding on the compressed data to generate compensation data, and convert the second image frame according to the compensation data, and
wherein an image is displayed on the display panel according to the converted second image frame.

9. The display device of claim 1, wherein the representative value is determined according to values of the source data units.

10. The display device of claim 1, wherein a maximum value of values of the source data units is determined as the representative value.

11. The display device of claim 1, wherein:
the pixels are grouped into a plurality of display areas;
an average value of values of the source data units corresponding to each of the display areas is determined as an area value corresponding to a display area; and
the representative value is determined according to the determined area values of the display areas.

12. The display device of claim 11, wherein a maximum value of the determined area values of the display area is determined as the representative value.

13. The display device of claim 1, wherein:
the pixels are grouped into a plurality of pixel groups,
the accumulated stress data includes accumulated stress data units respectively corresponding to the plurality of pixel groups, and
wherein the controller is configured to extract the source data units from the accumulated stress data units.

14. A method to operate a display device including pixels, the method comprising:
obtaining source data units from accumulated stress data corresponding to the pixels;
determining a representative value corresponding to the source data units;
changing a portion of data bits of each of the source data units according to the representative value, to generate changed source data units; and
encoding the changed source data units to generate compressed data.

15. The method of claim 14, further comprising displaying an image in the pixels based on an image frame and the compressed data,
wherein the displaying the image in the pixels comprises:
decoding the compressed data to generate compensation data;
converting the image frame according to the compensation data; and
displaying the image in the pixels according to the converted image frame.

16. The method of claim 14, wherein the changing comprises changing one or more least significant data bits of the data bits of each of the source data units to a first logic level.

17. The method of claim 16, wherein a number of the least significant data bits changed to the first logic level is adjusted according to the representative value.

18. The method of claim 14, wherein a maximum value of values of the source data units is determined as the representative value.

19. The method of claim 14, wherein:
the pixels are grouped into a plurality of display areas;
an average value of values of the source data units corresponding to each of the display areas is determined as an area value corresponding to a display area, and
the representative value is determined according to the determined area values of the display areas.

20. An electronic device comprising:
a processor; and
a display device configured to display an image in pixels according to image data from the processor,
wherein the display device comprises:
a display panel comprising the pixels;
a controller configured to control the display panel; and
a working memory connected to the controller,
wherein the controller is configured to:
update accumulated stress data corresponding to the pixels based on first image frames;
determine a representative value of source data units obtained from the accumulated stress data;
change a portion of data bits of each of the source data units according to the representative value, to generate changed source data units; and
encode the changed source data units to generate compressed data, and store the compressed data in the working memory.
